(19) United States
(12) Patent Application Publication
(10) Pub. No.: US 2009/0014209 A1
(43) Pub. Date: Jan. 15, 2009

(54) Cable Support Bracket

(76) Inventor: Robert C. Forbis, Naples, FL (US)

Correspondence Address: QUARLES & BRADY LLP, 411 E. WISCONSIN AVENUE, SUITE 2040, MILWAUKEE, WI, 53202-4497, US

(21) Appl. No.: 12/170,006

(22) Filed: Jul. 9, 2008

Related U.S. Application Data
(60) Provisional application No. 60/948,567, filed on Jul. 9, 2007.

(51) Int. Cl. H02B 1/40

(52) U.S. Cl. 174/480

(57) ABSTRACT

A cable support bracket which includes a backplate with a front surface and an opposed rear surface, and a first end and a second end opposed to the first end. At least one cable constraint is connected to the front surface, and each the cable constraint includes a post extending transversely from the front surface. Each post has a first lateral side and a second lateral side. Each cable constraint further includes a plurality of barbs on the first lateral side and/or the second lateral side. For each of the first lateral side and the second lateral side which includes the barbs, the barbs have an outer barb being furthest from the front surface, and at least one secondary barb between the outer barb and the front surface. The outer barb extends transversely from the post a greater distance than any of the secondary barbs.

### CROSS REFERENCES TO RELATED APPLICATIONS

This application claims the priority benefit of U.S. Provisional Patent Application No. 60/948,567 filed on Jul. 9, 2007, which is fully incorporated herein by reference.

### STATEMENT REGARDING FEDERALLY SPONSORED RESEARCH

Not Applicable.

### BACKGROUND OF THE INVENTION

This invention relates to cable support brackets for mounting electrical or optical cables/wiring to a wall, and more particularly to such brackets which can support the cables/wiring in a masonry wall construction.

Building and electrical codes, such as the National electrical Code (NEC), typically require that wiring be spaced from the face of the furring strips at least 1¼ inches or the wiring must be protected from fasteners, such as nails or drywall screws, when the wires are within 1¼ inches of a furring strip face. In masonry or concrete construction, often times vertical furring strips are used to prepare for interior walls, and these strips are typically ¾×1½ inch square, i.e. a 1×2 strip, which provides a space between the masonry wall and interior surface of the finish wall of approximately ¾ inches. The vertical furring strips typically have a lower end spaced above a horizontal 1×4 furring strip secured along the wall base. The 1×4 furring strip is also approximately ¾ inches deep, which also provides a space between the masonry wall and interior surface of the finish wall of approximately ¾ inches. As a result of the small gap between the masonry wall and interior surface of the finish wall, special techniques are required to ensure the wiring complies with the building and electrical codes.

One current method of complying with this requirement shown in FIG. 18 is to space the wire W from the vertical furring strip VF using a bracket B attached to the furring strip. This particular method meets the minimal requirement of the requirement while exposing the wire to an errant drywaller that fails to hit the furring strip when fastening drywall to the furring strip. Moreover, the brackets merely space the wire from the furring strip, but fail to hold the wires relative to the bracket. As a result, inadvertent wire movement cause by tradesmen working on the wall after the wire is installed can disengage the wire from the bracket causing the wire location to violate the building code requirements after the wiring is inspected.

The code requirement must also be met when running wire horizontally along the horizontal furring strip HF. The bracket B used to space the wires relative to the vertical furring strip VF is often used to space the wires relative to the horizontal furring strip HF. Because the bracket is attached to the horizontal furring strip adjacent the lower end of the vertical furring strip to guide the wire through the gap between the horizontal and vertical furring strips, the bracket must be covered once the wires are placed in the bracket. As a result, the electrician/installer is required to fabricate a cover C to place over the wires where they are supported, to protect from drywall screws. Currently the nail covers are spiked into a convenient furring strip independent of the bracket B and sits on top of the furring strip. Often by the time the insulation installers are finished installing the insulation the nail plates are laying on the floor and the protection is gone. Also, builders remove the nail plates during or after inspection, and before the drywall is installed, as they don't want the drywall distorted by the nail plates.

U.S. Design Pat. Nos. D326,999 and D336,421 disclose the ornamental design for a cable stacking device and a cable retainer, respectively; however, these devices do not hold the cables securely resulting in a sloppy wiring job, which is contrary to the NEC which requires that work be done in a neat and workmanlike manner. Other disadvantages are that they need to adapted by the electrician for this use, which takes time, and they don't have adequate accommodations for fixing the device or retainer to a wall, and consequently these devices and retainers can rotate in use. Additionally, there are no provisions for a nail cover in the event of masonry construction with furring strips, and these devices and retainers are in general less suited for masonry construction than for stud construction.

U.S. Pat. No. 5,659,949 discloses a method of manufacturing a wiring harness which includes a plate on which wire clips are mounted to facilitate the positioning of individual wires. While this tooling device is suitable for its intended purpose of manufacturing a wiring harness made up of individual wires, it is not suitable for holding 3-wire, and other, cables above an electrical box as the clips are not suitable for holding such cables. Further, there are no elements for easily mounting the assembly to a wall, and if the assembly was wall mounted, there are no provisions for providing the correct spacing to keep the wires 1¼ inches back from the face of the stud so that drywall screws can't hit the wires accidentally. Additionally, there are no provisions for a nail cover in the event of masonry construction with furring strips.

U.S. Pat. No. 5,370,558 discloses a fixture for supporting a splicing module for telecommunications cables which has a body member, generally the size of a comb, formed with a series of raised teeth, spaced opposite edges, corresponding to the spacing of the contacts, and wire receiving channels in the splicing module. The teeth are spaced and are formed to receive and locate the wires in relationship to a splicing module placed on the body member between the rows of teeth. A retainer body member has an elongated planar portion with an upper and a lower surface which includes registration alignment posts on the body which cooperate with openings in the ends of the base to insure proper alignment of the body and base. Although this device has some advantages as a splicing fixture, it has the same drawbacks as the U.S. Pat. No. 5,659,949 discussed above.

See also U.S. Pat. Nos. 3,659,319, 4,253,629, 4,097,106, 4,601,530, 4,836,803, 5,554,053.

Notwithstanding these developments, what is needed in the art is a cable support bracket which securely holds the cables, which is suitable for masonry or stud construction and particularly includes a nail cover, and which can be fastened securely to different types of construction.

### SUMMARY OF THE INVENTION

The invention provides, in one form thereof, a cable support bracket which includes a backplate with a front surface and an opposed rear surface, and a first end and a second end opposed to the first end. At least one cable constraint is connected to the front surface, and each cable constraint includes a post extending transversely from the front surface. Each post has a first lateral side and a second lateral side. Each cable constraint further includes a plurality of barbs on the first lateral side and/or the second lateral side. For each of the first lateral side and the second lateral side which includes the barbs, the barbs have an outer barb being furthest from the front surface, and at least one secondary barb between the outer barb and the front surface. The outer barb extends transversely from the post a greater distance than any of the secondary barbs.

The invention provides, in another form thereof, a cable support bracket which includes a backplate with a front surface and an opposed rear surface, and a first end and a second end opposed to the first end. At least one cable constraint is connected to the front surface, and each cable constraint includes a post extending transversely from the front surface. A cover extends over the at least one cable constraint and is connected to the cable support bracket.

Objects and advantages of the invention will appear from the following description. In the description, reference is made to the accompanying drawings which form a part hereof, and in which there is shown by way of illustration a preferred embodiment of the invention.

### BRIEF DESCRIPTION OF THE DRAWINGS

FIG. 1 is an elevation view of an electrical arrangement according to the present invention;

FIG. 2 is an exploded perspective view of the cable support bracket of FIG. 1, and illustrating in part how different size nail plates can be used as part of the bracket;

FIG. 3 is a cross-sectional view taken along section line 3-3 in FIG. 1;

FIG. 4 is an perspective view of the cable support bracket of FIG. 1;

FIG. 5 is a front view of the cable support bracket of FIG. 1;

FIG. 6 is a top view of the cable support bracket of FIG. 1;

FIG. 7 is end view of the cable support bracket of FIG. 1;

FIG. 8 is rear view of the cable support bracket of FIG. 1;

FIG. 9 is a fragmentary perspective view of another electrical arrangement including an electrical box mounted between studs on a wall, and another embodiment of the cable support bracket according to the present invention;

FIG. 10 is a perspective view of the cable support bracket of FIG. 9;

FIG. 11 is a cross-sectional view taken along section line 11-11 in FIG. 9;

FIG. 12 is an perspective view of the cable support bracket of FIG. 9;

FIG. 13 is a front view of the cable support bracket of FIG. 9;

FIG. 14 is a top view of the cable support bracket of FIG. 9;

FIG. 15 is end view of the cable support bracket of FIG. 9;

FIG. 16 is another end view of the cable support bracket of FIG. 9;

FIG. 17 is rear view of the cable support bracket of FIG. 9; and

FIG. 18 is an elevation view of prior art electrical arrangement on a masonry wall.

Before one embodiment of the invention is explained in detail, it is to be understood that the invention is not limited in its application to the details of the construction and the arrangements of components set forth in the following description or illustrated in the drawings. The invention is capable of other embodiments and of being practiced or being carried out in various ways. Also, it is understood that the phraseology and terminology used herein is for the purpose of description and should not be regarded as limiting.

### DESCRIPTION OF THE PREFERRED EMBODIMENT

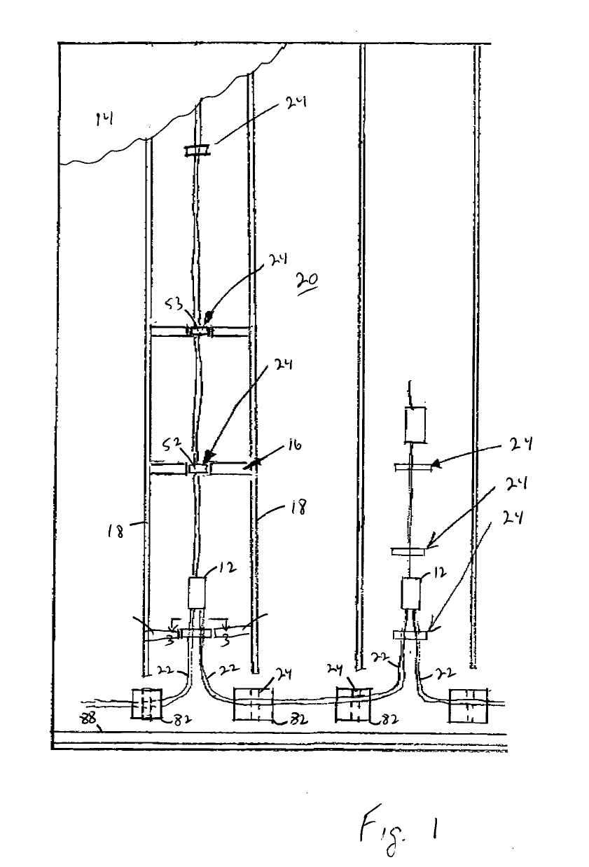

Referring now to the drawings, and more particularly to FIG. 1, there is shown an electrical arrangement 10 which includes an electrical box 12 which is mounted in proximity to a first wall 14, such as an inside drywall, having an inner surface facing a second wall 20. The electrical box 12 may be connected to second wall 20, and drywall 14 may be supported by furring strips 18, which are connected to second wall 20, which can be a concrete or masonry wall, for example. Cables 22 are secured and supported by cable support bracket 24. Cables 22 may be terminated in electrical box 12. Cables 22 are shown as three conductor power cables which may be required by the NEC to be at least a minimum distance from the inner surface of wall 14, or alternatively, be covered in the vicinity of cable support bracket 24. Cables 22 can be other types of cables such as communications, TV, fiber optics, control, or other cable types, which may not be required to be a certain distance from the inner surface of wall 14, and which may be connected to cable support bracket 24.

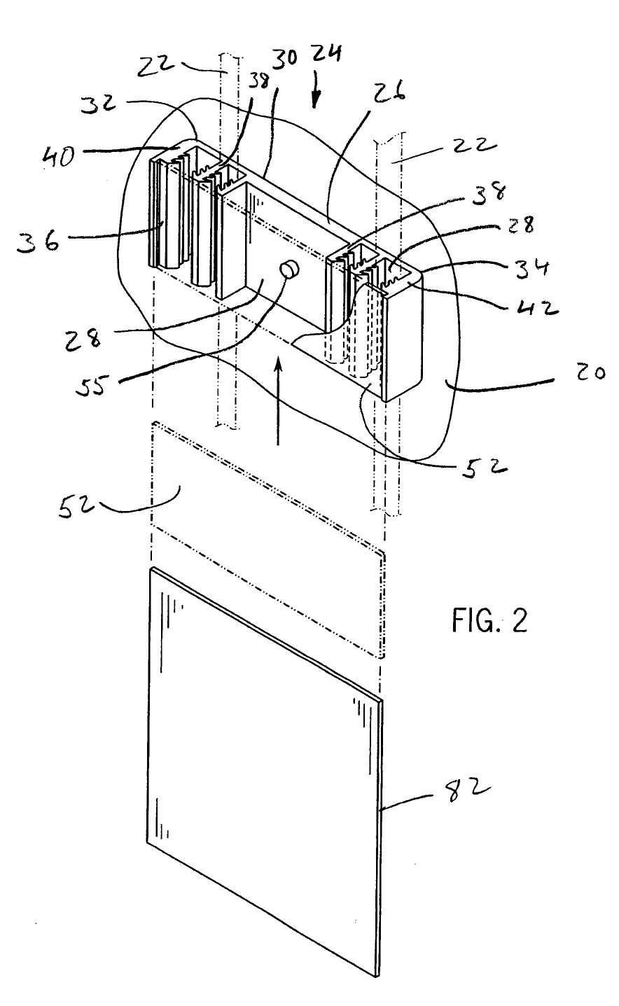

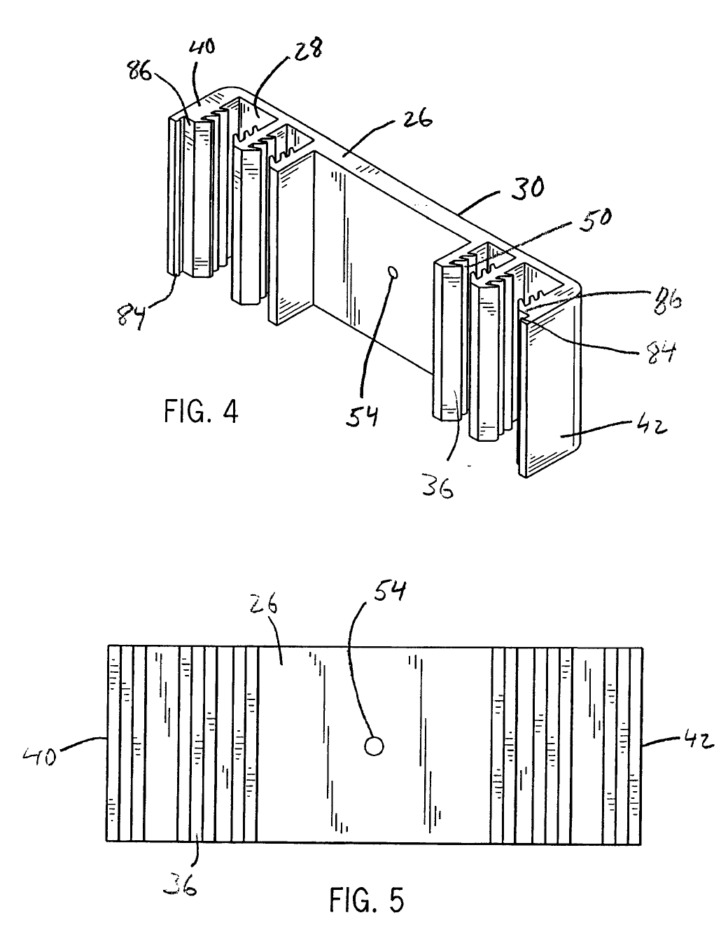

Referring more particularly to FIGS. 2-8, cable support bracket 24, preferably formed from a fire resistant polyvinyl chloride (PVC), or other plastic or materials, includes a backplate 26 which has a front surface 28 and an opposed rear surface 30, and a first end 32 and a second end 34 opposed to first end 32. Backplate 26 includes at least one fastener hole 54 therethrough, and bracket 24 can further include a fastener 55 such as a masonry, or other, nail, or other fastener type such as screws. Preferably, the fastener 55 is frictionally retained in the fastener hole 54 for easy installation. Advantageously, the fastener 55 can secure the cable support bracket 24 directly to the second wall 20 spaced from the furring strips 18 and avoiding the need to cover the bracket 24 and protect the cables 22.

At least one cable constraint 36 is connected to front surface 28. Each cable constraint 36 includes a post 38, 40 or 42, extending transversely from front surface 28, and each post has a first lateral side 44 and a second lateral side 46, each said cable constraint further including a plurality of barbs 48, 50 on at least one of first lateral side 44 and second lateral side 46. For each of first lateral side 44 and second lateral side 46 which includes the barbs, an outer barb 48 is furthest from front surface 28, and at least one secondary barb 50 is between outer barb 48 and front surface 28. Outer barb 48 extends transversely from a respective post a greater distance than any of the corresponding secondary barbs 50. Advantageously, the outer barb 48 extending further away from the post than the secondary barbs 50 prevents the cable 22 from easily slipping out of the grip of the barbs 48, 50 between the respective posts 38, 40, 42 to properly constrain the cable 22.

The cable constraints 36 include at least one acutely angled barb 48, 50 directed toward front surface 28, that is, barbs 48, 50 are angled toward front surface 28 at an acute angle relative to posts 38, 40 and 42. Advantageously, the acutely angled barbs resist removal of the cable 22 from engagement with the barbs 48, 50 when pulling the cable 22 away from the front surface 28. In the embodiment disclosed herein, cable constraint 36 includes opposed barb pairs 56, 58 and 60 which include a respective first tip 62, 64, 66 and a respective second tip 68, 70, 72 which are preferably approximately equidistant from front surface 28.

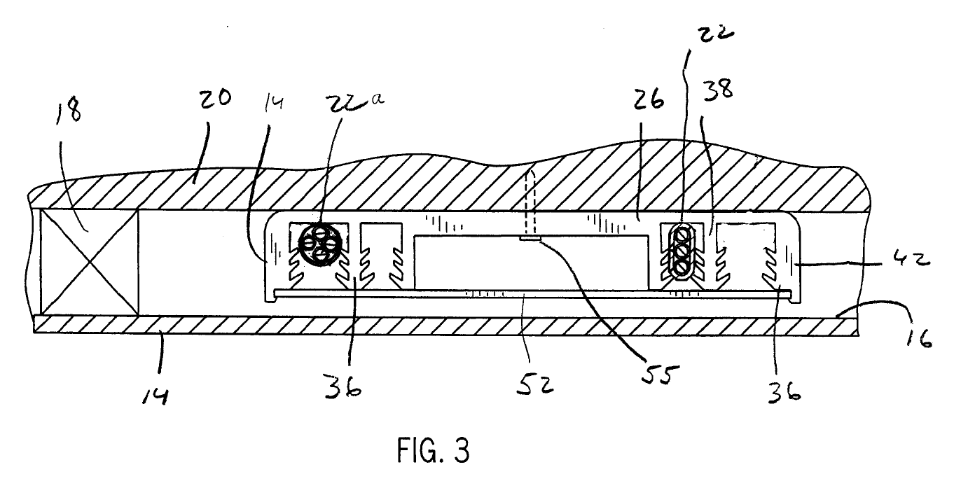

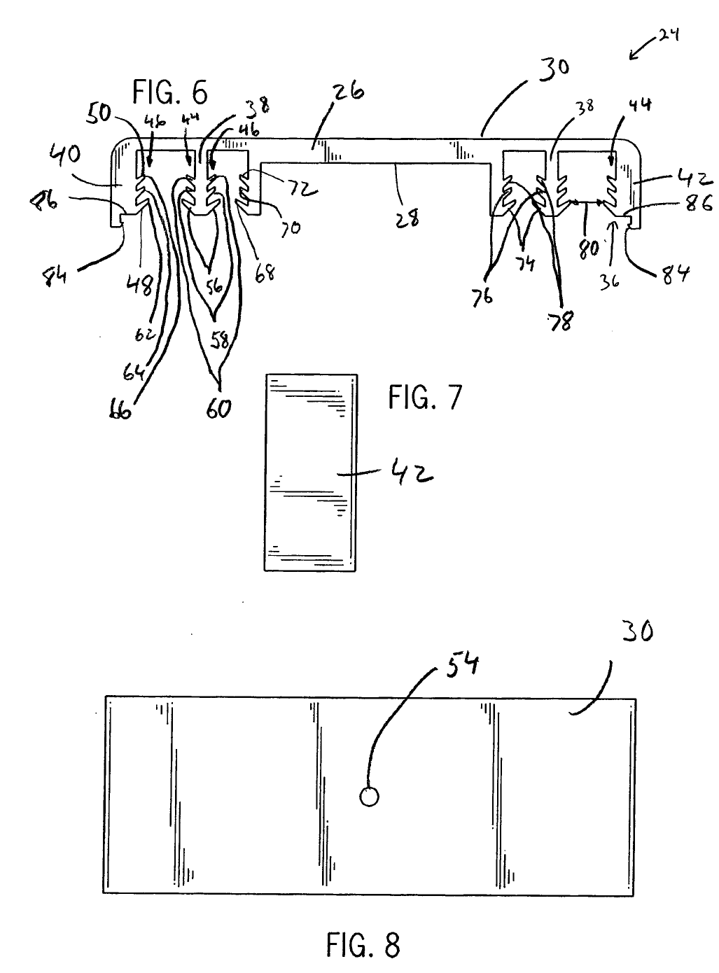

As shown in FIG. 6, the cable support bracket 24 can include a second post including a second plurality of acutely angled barbs 48, 50 on a second lateral side of any posts 38. Consequently, barb pairs 74, 76 and 78 are also formed by adjoining posts 38, 40, or 42, which pairs have characteristics similar to barb pairs 56, 58, 60. Each of opposed barb pairs 74, 76 and 78 therefore also include outer barbs 48 extending further than secondary barbs 50, and a respective first tip 62, 64, 66 and a respective second tip 68, 70, 72 which are approximately equidistant from front surface 28. Opposed barb pairs 74, 76 and 78 include an outer opposed barb pair 74 comprised of two outer barbs 48, with a gap 80 between the barbs, where gap 80 is smaller than the other gaps of pairs 76, 78. Advantageously, the opposed barb pairs 74, 76, 78 allow easy insertion of the cable 22 between adjacent cable constraints 36 while the acutely angled barbs resist removal of the cable 22 from the cable support bracket 24. Of course, as shown in FIG. 3, the gap can vary to accommodate a different size or shape cable 22a compared to cable 22.

A cover 52 is removably connected to cable support bracket 24 and extends over the cable constraints 36 to protect the cable 22 secured relative to the cable support bracket 24 by the constraints 36. Preferably, the cover 52 extends between a first end post 40 extending orthogonally from a first end 32 of the cable support bracket 24 and a second end post 42 extending orthogonally from a second end 34 of the cable support bracket 2. Advantageously, the cover 52 protects the cables 22 retained by the cable constraints 36 when the cables cannot meet spacing requirements, such as shown in FIG. 1 when studs 16 extend inwardly from the furring strips 18 toward the bracket 24. The cover 52 shown in FIG. 2 has a width approximately equal to a width of the cable support bracket 24 to protect the portion of the cables 24 engaging the cable support bracket 24. An oversize cover 82, shown in FIGS. 1 and 2 can be provided, that extends out on each side of the cable support bracket 24 to provide additional protection beyond the width of the cable support bracket 24 when required by the NEC or other codes, such as when the cables come in close proximity to both the vertical furring strips 18 and a base board 88, as shown in FIG. 1.

Preferably, each of first end post 40 and second end post 42 includes an outer ramped projection 84 adjoining a ledge 86. The projection 84 retains the cover on the ledge 86 to hold the cover in place. Advantageously, the ramped projection 84 allows a user to snap the cover 52 in place and engage outer ramped projections 84 and ledges 86 of each of posts 40, 42. Although providing end posts 40, 42 that have projections 84 to retain the cover 52 in place is preferred, other methods for holding the cover 52 in place can be provided, such as fasteners joining fastening the cover to posts or the backplate, posts extending from the cover engaging the backplate or posts, and the like, without departing from the scope of the invention.

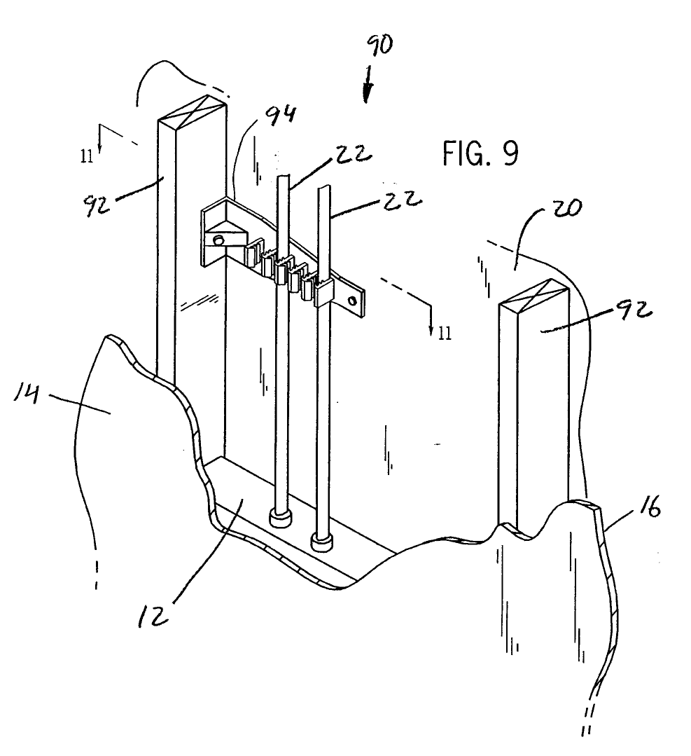

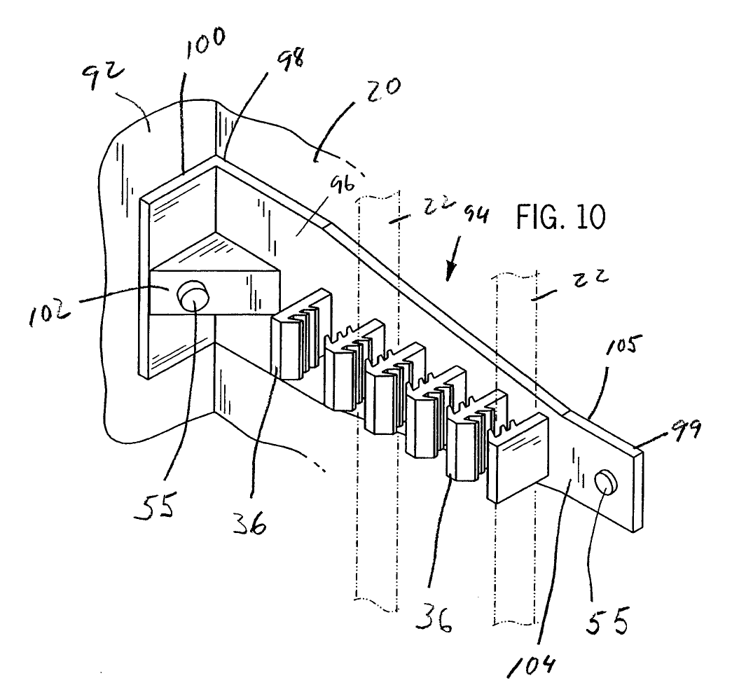

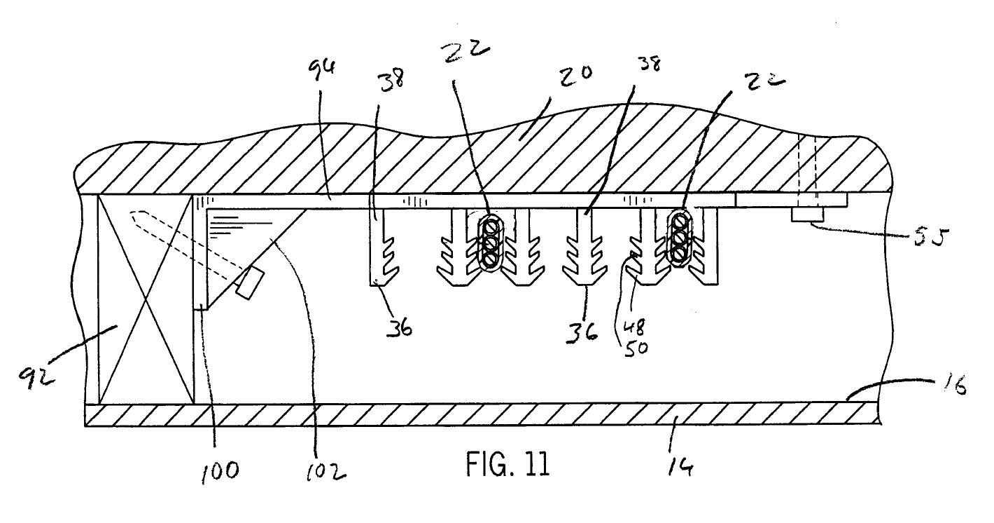

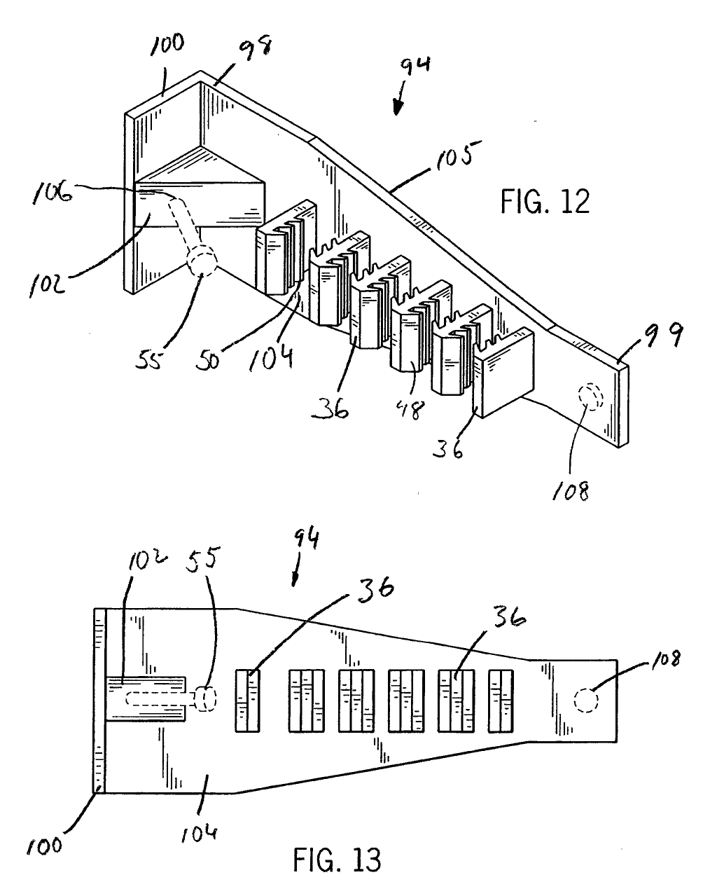

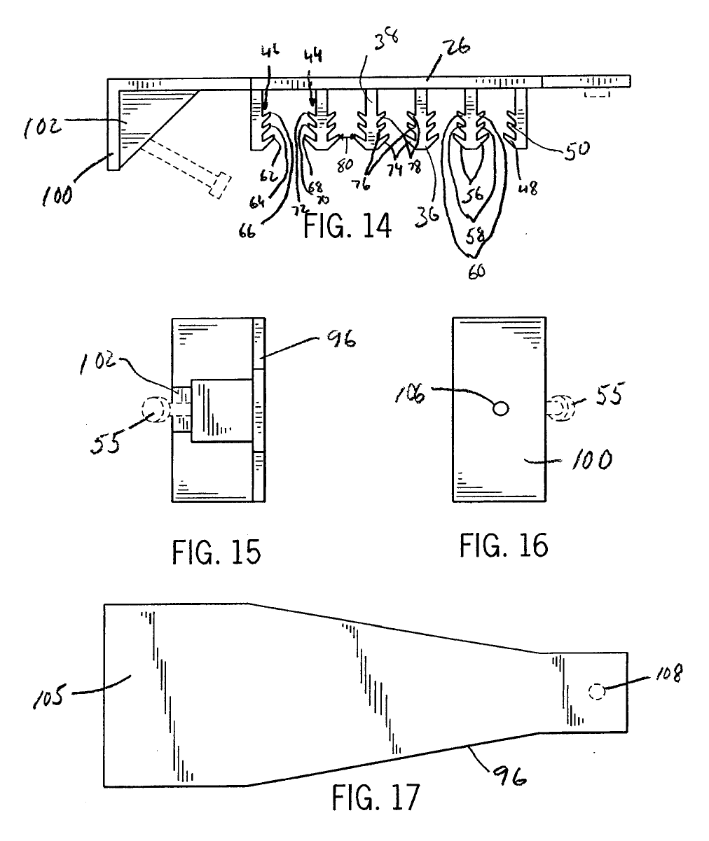

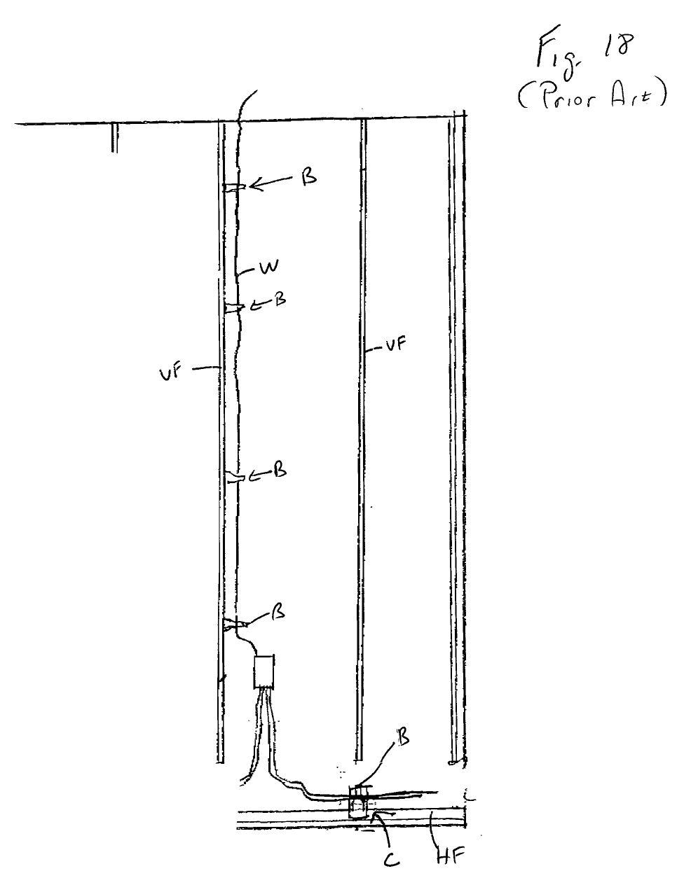

In another embodiment (FIGS. 9-17), there is shown an electrical arrangement 90 which includes an electrical box 12 which is mounted in proximity to a first wall 14, such as an inside drywall, having an inner surface facing a second wall 20. The electrical box 12 may be connected to a second wall 20, and drywall 14 may be supported by studs 92, which are connected to a second wall 20, which can be a concrete or masonry wall, for example. Cables 22 are secured and supported by cable support bracket 94.

Cable support bracket 94 includes cable constraints 36 with barbs 48, 50 as previously described, and also includes backplate 96 with first end 98 which has a first end post 100 (and an opposing second end 99) and a brace 102 directly connected to first end post 100 and front surface 104 of backplate 96. Backplate 96 includes rear surface 105. First end post 100 and brace 102 includes a fastener hole 106 therethrough, and can include other fastener holes as shown at 108.

While there has been shown and described what are at present considered the preferred embodiment of the invention, it will be obvious to those skilled in the art that various changes and modifications can be made therein without departing from the scope of the invention defined by the appended claims. Therefore, various alternatives and embodiments are contemplated as being within the scope of the following claims particularly pointing out and distinctly claiming the subject matter regarded as the invention.

I claim:

1. A cable support bracket, comprising:
a backplate including a front surface and an opposed rear surface, and a first end and a second end opposed to said first end; and
at least one cable constraint connected to said front surface, each said cable constraint including a post extending transversely from said front surface, each said post having a first lateral side and a second lateral side, each said cable constraint further including a plurality of barbs on at least one of said first lateral side and said second lateral side, and for each of said first lateral side and said second lateral side which includes said barbs, said barbs have an outer barb being furthest from said front surface, and at least one secondary barb between said outer barb and said front surface, said outer barb extending transversely from said post a greater distance than any of said at least one secondary barb.

2. The cable support bracket of claim 1, wherein each of said outer barb and said at least one secondary barb are directed toward said front surface at an acute angle.

3. The cable support bracket of claim 1, including a cover connected to cable support bracket and extending over said at least one cable constraint.

4. The cable support bracket of claim 3, in which said first end includes a first end post and said second end includes a second end post, and said cover is connected to said first end post and said second end post.

5. The cable support bracket of claim 1, wherein said first end includes a first end post and a brace directly connected to said first end post and said front surface.

6. The cable support bracket of claim 5, wherein said first end post and said brace includes a fastener hole therethrough.

7. The cable support bracket of claim 6, including a fastener retained in said fastener hole.

8. The cable support bracket of claim 1, wherein said backplate includes a fastener hole therethrough.

9. The cable support bracket of claim 8, including a fastener retained in said fastener hole.

10. The cable support bracket of claim 1, wherein said at least one cable constraint comprises a first post having a first plurality of acutely angled barbs on a first lateral side of said post and a second plurality of acutely angled barbs on a second lateral side of said post.

11. The cable support bracket of claim 10, wherein said first plurality of acutely angled barbs and said second plurality of acutely angled barbs include opposed barb pairs.

12. The cable support bracket of claim 11, wherein each of said opposed barb pairs include a first tip and a second tip which are approximately equidistant from said front surface.

13. The cable support bracket of claim 1, wherein at least one said cable constraint comprises a first post having a first plurality of acutely angled barbs on a first lateral side of said first post and a second post including a second plurality of acutely angled barbs on a second lateral side of said second post.

14. The cable support bracket of claim 13, wherein said first plurality of acutely angled barbs and said second plurality of acutely angled barbs include opposed barb pairs.

15. The cable support bracket of claim 14, wherein each of said opposed barb pairs include a first tip and a second tip which are approximately equidistant from said front surface.

16. A cable support bracket, comprising:
a backplate including a front surface and an opposed rear surface, and a first end and a second end opposed to said first end;
at least one cable constraint connected to said front surface, each said cable constraint including a post extending transversely from said front surface; and
a cover extending over said at least one cable constraint and connected to said cable support bracket.

17. The cable support bracket of claim 16 including a first end post connected to said first end and extending transversely from said backplate and a second end post connected to said second end and extending transversely from said backplate, said cover being connected to said first end post and said second end post.

18. The cable support bracket of claim 17, wherein each of said first end post and said second end post includes an outer ramped projection adjoining a ledge, said cover engaging said outer ramped projection and said ledge of each of said first end post and said second end post.

19. The cable support bracket of claim 18, wherein each of said post, said first end post and said second end post has a first lateral side and a second lateral side, each said cable constraint further including a plurality of barbs on at least one of said first lateral side and said second lateral side, and for each of said first lateral side and said second lateral side which includes said barbs, said barbs have an outer barb being furthest from said front surface, and at least one secondary barb between said outer barb and said front surface, said outer barb extending transversely from said post a greater distance than any of said at least one secondary barb.
